(19) United States
(12) Patent Application Publication
(10) Pub. No.: US 2013/0080481 A1
(43) Pub. Date: Mar. 28, 2013

(54) EXTREME LARGE SPACE ALLOCATION

(71) Applicants: Panfeng ZHOU, Pleasanton, CA (US); Shampa Chakravarty, Moraga, CA (US); Elton Philip Wildermuth, Oakland, CA (US); Yanhong Wang, San Ramon, CA (US)

(72) Inventors: Panfeng ZHOU, Pleasanton, CA (US); Shampa Chakravarty, Moraga, CA (US); Elton Philip Wildermuth, Oakland, CA (US); Yanhong Wang, San Ramon, CA (US)

(73) Assignee: Sybase, Inc., Dublin, CA (US)

(21) Appl. No.: 13/246,278

(22) Filed: Sep. 27, 2011

(51) Int. Cl. G06F 17/30

(52) U.S. Cl. 707/803; 707/E17.044; 707/E17.005

(57) ABSTRACT

Methods, systems, and computer program products are provided to efficiently allocate extremely large storage spaces for use by dynamic hash tables. A contiguous storage space is designated from which dynamic hash tables can be created. These dynamic hash tables benefit from rapid allocation by being able to reserve many allocation units (each potentially comprising a large number of pages, e.g., 256 pages) within a short span of time, rather than resorting to reserving individual pages. The efficiency from allocation and the contiguous space significantly improves performance for databases in the 50 GB-100 GB size range.

### BACKGROUND OF THE INVENTION

1. Field of the Invention

The present invention relates generally to databases and, more specifically, to improvements in efficiency for allocating hash tables.

2. Background Art

Data in a database is often stored in the form of a hash table. A number of pages of data are allocated for the table, and a hash function is applied to each row of data in the table to determine on which page and position within the page the row should be stored.

For large sets of data, allocation of pages becomes a challenge. In particular, it is computationally expensive to consult each page for information regarding its availability. Moreover, this approach makes it costly to obtain contiguous sets of pages, such that it is not possible to realize the additional benefits of memory access to contiguous data space in, e.g., hard disk drives.

One existing solution, termed Large Scale Allocation (“LSA”), involves the ability to allocate contiguous extents of pages. However, the sizes of these extents are inflexible, such that allocation is still not sufficiently fast for extremely large space allocations (e.g., gigabytes of data). Additionally, there is no guarantee that the next set of contiguous extents of pages will be contiguous with respect to the previous extent, potentially fragmenting these extremely large datasets.

Accordingly, what is desired is an efficient manner to allocate storage space for extremely large hash table datasets.

### BRIEF SUMMARY OF THE INVENTION

Embodiments of the invention include a method comprising creating a dynamic hash table segment on a database, and creating a dynamic hash table within the dynamic hash table segment, the dynamic hash table comprising one or more contiguous allocation units having a plurality of contiguous pages and allocated on a per-allocation unit basis.

Additional embodiments of the present invention include a computer-readable storage device having stored thereon instructions, execution of which, by a computing device, cause the computing device to perform operations comprising creating a dynamic hash table segment on a database, and creating a dynamic hash table within the dynamic hash table segment, the dynamic hash table comprising one or more contiguous allocation units having a plurality of contiguous pages and allocated on a per-allocation unit basis.

Further embodiments of the present invention include a system comprising a memory configured to store modules comprising a first creating module configured to create a dynamic hash table segment on a database, and a second creating module configured to create a dynamic hash table within the dynamic hash table segment, the dynamic hash table comprising one or more contiguous allocation units having a plurality of contiguous pages and allocated on a per-allocation unit basis, and one or more processors configured to process the modules.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates a database management system, in accordance with an embodiment of the present invention.

FIG. 2 is a flowchart illustrating steps by which a dynamic hash table is allocated in accordance with an embodiment of the present invention.

FIG. 3 is a flowchart illustrating steps by which a dynamic hash table is allocated, in accordance with an embodiment of the present invention.

FIG. 4 is a flowchart illustrating steps by which atomicity is preserved, in accordance with an embodiment of the present invention.

FIG. 5 is a diagram illustrating the relationship of exemplary space management components, in accordance with an embodiment of the present invention.

FIG. 6 depicts an example computer system in which embodiments of the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, and within the scope and spirit of the present invention.

Reference to modules in this specification and the claims means any combination of hardware or software components for performing the indicated function. A module need not be a rigidly defined entity, such that several modules may overlap hardware and software components in functionality. For example, a software module may refer to a single line of code within a procedure, the procedure itself being a separate software module. One skilled in the relevant arts will understand that the functionality of modules may be defined in accordance with a number of stylistic or performance-optimizing techniques, for example.

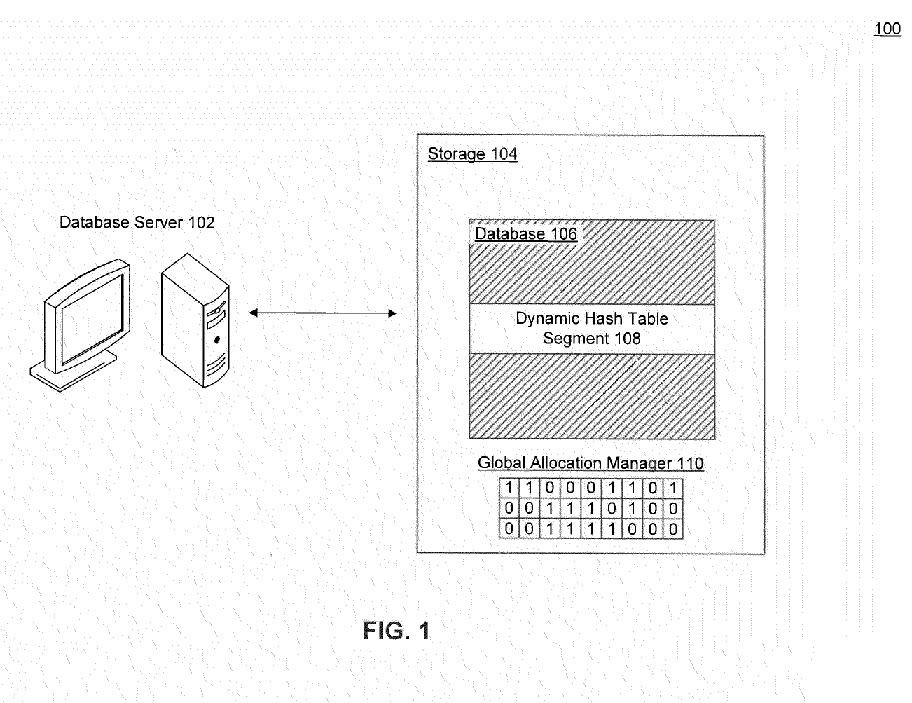

FIG. 1 illustrates a database management system (“DBMS”) 100, in accordance with an embodiment of the present invention. DBMS 100 comprises a database server component 102 configured to run database server software. In a non-limiting exemplary embodiment, this database server software comprises the Adaptive Server Enterprise (“ASE”) Relational Database Management Server (“RDBMS”) software developed by Sybase, Inc. DBMS 100 further comprises storage 104, on which database 106 is stored. Database 106 comprises data that can be served by DBMS 100 to one or more clients of the system.

As will be discussed in further detail below, database 106 comprises an area of memory within storage 104 that is designated as a dynamic hash table segment 108. This dynamic hash table segment 108 is used to store dynamic hash tables (“DHT”) in accordance with embodiments of the present invention.

Storage 104 further comprises a global allocation manager (“GAM”) 110, including operations for manipulating data values stored by the GAM. GAM 110 is used to manage allocation of data pages, such as those utilized by the DHTs, in accordance with an embodiment of the present invention. This functionality will also be discussed in further detail below.

### II. Hash Table Performance

Certain data types benefit tremendously from organization in a hash table. Many RDBMS implementations have techniques for providing hash table organizations for their data, including a particular hash function used to determine a slot for data being inserted into the hash table. In accordance with an embodiment of the present invention, efficiency for data storage and access using the hash table is improved through the use of contiguous storage space. For example, in the case of a hard drive, access to sequential blocks of data is more efficient than having to seek across the disk for subsequent blocks.

An example of a query that can benefit from these performance improvements is an exact-match (point) query, such as:

SELECT*FROM orders WHERE id=1 AND age=10

Since point-query is a basic query for many more complicated operations, these performance improvements can impact the overall performance of the RDBMS. For example, it has been observed in prototype experiments that a JOIN operation using the hash table can be several times faster than using a B-tree index.

Where storage space is allocated in the form of pages, allocating space for a very large hash table becomes computationally expensive. In an alternative method, each page is allocated individually, and there is no guarantee that the next page will be in contiguous space relative to the previous page. While this provides the benefits of contiguous space access to data that fits within a single page, the benefits are lost on larger data sets occupying many pages.

In the alternative, pages may be allocated in sets that are guaranteed to be contiguous (e.g., single allocation of sets of 31 pages). While this is an improvement on page-by-page allocation, there is still no guarantee that the next set of contiguous pages will be contiguous to the prior set. As a result, this is still not a reasonable solution for extremely large data sets (e.g., 100 GB) that will need to allocate many of these sets of pages for storage. The solution is an exemplary implementation termed Extreme Large Space Allocation (“ELSA”), which is described in detail herein.

### III. Creating Dynamic Hash Tables

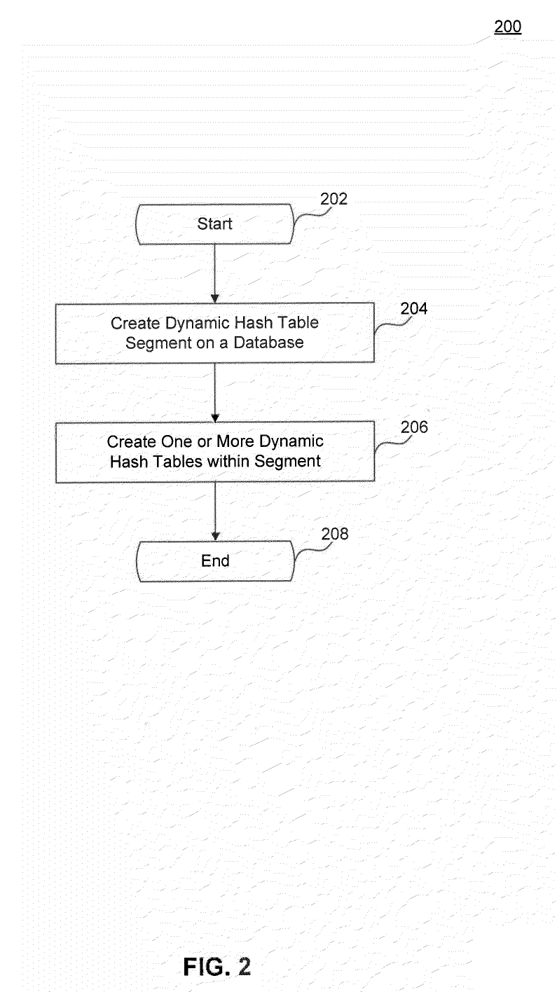

FIG. 2 is a flowchart 200 illustrating steps by which a dynamic hash table is allocated in accordance with an embodiment of the present invention. The method begins , at step 202 and proceeds to step 204 where a dynamic hash table segment is created on a database. This dynamic hash table segment comprises a contiguous memory segment, such that dynamic hash tables created on that segment will utilize contiguous storage space.

Creating a dynamic hash table segment can be accomplished, in accordance with an embodiment, at the time the database is created (e.g., using a “create database” command), or an existing database can be configured to use a dynamic hash table segment (e.g., using an “alter database” command).

A dynamic hash table segment is reserved for use strictly by dynamic hash tables, arid would not be used by non-DHT objects (e.g., normal user tables, indices, etc.), in accordance with an embodiment of the present invention.

The method proceeds to step 206, where one or more dynamic hash tables are created within the segment, in accordance with an embodiment of the present invention. The method then ends at step 208.

### IV. Allocation for Dynamic Hash Tables

With a reserved dynamic hash table segment, it is then possible to allocate space from this segment for use by a dynamic hash table. This is accomplished, by way of non-limiting example, by indicating that a table should utilize the dynamic hash table segment at the time the table is created.

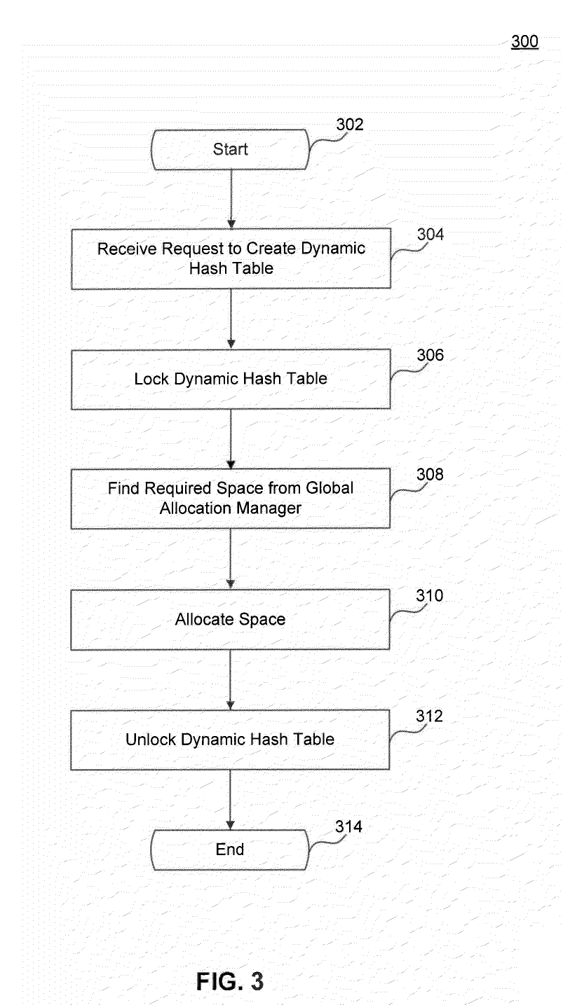

FIG. 3 is a flowchart 300 illustrating steps by which a dynamic hash table is allocated, in accordance with an embodiment of the present invention. The method begins at step 302 and proceeds to step 304 where a request to create a dynamic hash table is received (e.g., by the RDBMS).

In order to prevent issues arising from space contention (e.g., attempts to allocate the same space from the segment to two or more tables), a lock is obtained at step 306. In accordance with an embodiment of the present invention, this lock is used to block concurrent creators or droppers of dynamic hash tables. This can be handled by, for example, using the lock to protect access to the GAM, preventing execution threads that do not have a lock from allocating or deallocating pages.

The lock can also be handled in different ways depending on the topology of a computer system on which the RDBMS is executing. For example, in the case of a Symmetric Multiprocessor (“SMP”) system, the lock can be implemented as a spinlock. In this case, a thread of execution seeking access to the GAM will poll the spinlock until it becomes available, and then will proceed with the allocation methodology detailed below. In the alternative example of a Shared Disk Cluster (“SDC”), the lock is based on a globally unique identifier (“GIRD”).

With exclusive access to the GAM provided by the lock, it is then possible to consult the GAM at step 308 to find the required space, in accordance with an embodiment of the present invention. The GAM includes an array or similar construct indicating the availability of a set of allocation units (“AU”). In accordance with an embodiment of the present invention, one AU comprises 256 pages (contiguous), although one skilled in the relevant arts will appreciate that this correspondence can vary as needed.

In one exemplary implementation, the GAM's array is an array of bits, each bit being associated with a corresponding AU. Each bit has a value of either ‘1’, indicating that the corresponding AU has been fully allocated, or ‘0’, indicating that one or more pages within the corresponding AU are free. In an alternative exemplary implementation, a value of ‘0’ is used only when the entire AU is completely free, and a value of P is used when at least some portion of the AU has been allocated. While this second approach may potentially waste pages by allocating space only at AU boundaries, it will save some time required to search within an AU for the beginning of unallocated space.

Regardless of the approach used, the necessary number of pages can be reserved in the GAM by identifying a group of contiguous unallocated pages (the GAM bits are in sequence of contiguous AUs, each with contiguous pages). By this methodology, as described in further detail below, space for the dynamic hash table is allocated at step 310. The lock can then be released at step 312, and the method ends at step 314.

While the lock is in effect, other parts of the database can continue to be accessed in parallel. In particular, the lock does not affect access to non-DHT storage space, such that the benefits of this approach can be realized separately from other portions of the database system that are not also using this approach.

### V. Reserving Space Using the GAM

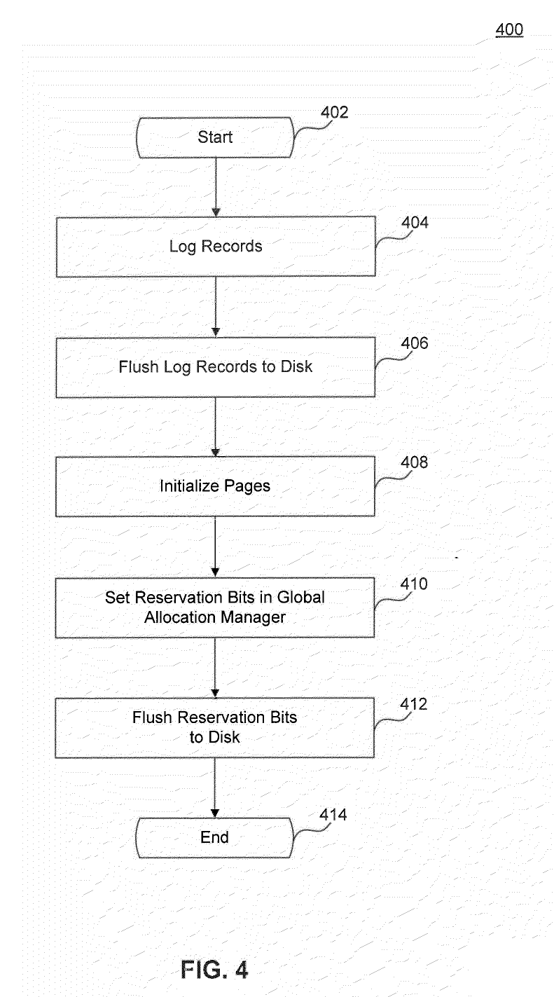

While reserving space using the GAM is accomplished by simply toggling the GAM bits to, e.g., ‘1’ for the necessary space, certain additional precautions should be taken to ensure atomicity of the reservation process. FIG. 4 is a flowchart 400 illustrating steps by which atomicity is preserved, in accordance with an embodiment of the present invention.

The method begins at step 402 and proceeds to step 404 where records are logged, in accordance with an embodiment of the present invention. In a non-limiting exemplary embodiment, a record is created for each fragment of data being created, and includes old and new timestamps for each GAM page. At step 406, these log records are then flushed to disk. Notably, at this point, a failure can still be recovered from because the GAM has not yet been modified.

Next, at step 408, the pages within each AU are initialized. In accordance with a non-limiting embodiment, each AU comprises an allocation page (“AP”), and each dynamic hash table comprises an Object Allocation Management (“OAM”) page, although one of ordinary skill in the relevant art will appreciate that other management techniques may be utilized. The allocation page for each allocation unit is used to indicate which pages within the AU have been allocated or are free (at the page level, as opposed to the GAM which operates at the AU level). The OAM for each dynamic hash table contains memory address information for the pages being used by the DHT within the allocation pages. Additionally, the “new” timestamp procured earlier when logging the records is used as the timestamp for the modified pages.

At this point, if there is a failure when modifying the information in the APs and the OAM, it is possible to use the log records (preserved by flushing to disk) to revert any partial changes made to this information. This is based on existing recovery mechanisms that operate on a page-by-page basis, although one of ordinary skill in the art will recognize that the techniques used to preserve atomicity can be modified to operate with other recovery mechanisms.

If everything is successful, the method then proceeds to step 410 where the GAM space is reserved by setting the corresponding bits for the reserved AUs. At step 412, the GAM bits are flushed to disk, and the method ends at step 414.

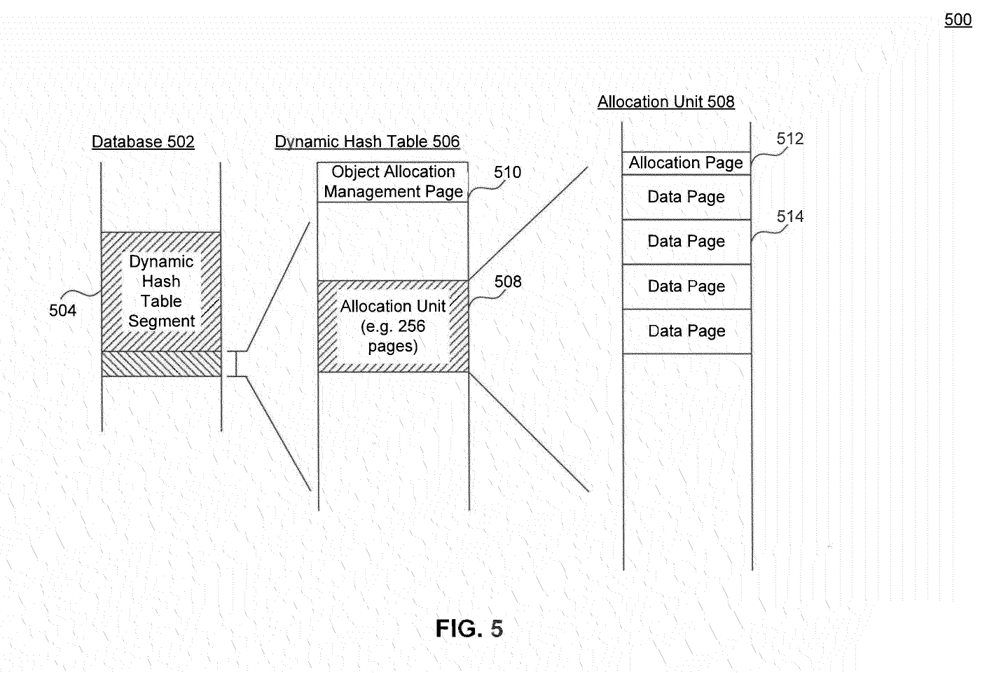

FIG. 5 is a diagram 500 illustrating the relationship of the aforementioned exemplary memory management components, in accordance with an embodiment of the present invention. As shown on the left portion of FIG. 5, a database 502 has a dynamic hash table segment 504 that has been specifically reserved for use by dynamic hash tables.

As shown in the middle portion of FIG. 5, a dynamic hash table 506 is allocated within a portion of dynamic hash table segment 504. Dynamic hash table 506 has an Object Allocation Management page 510 that tracks the memory locations of the various data pages used by dynamic hash table 506. Dynamic hash table 506 comprises one or more allocation units 508, which are shown in FIG. 5 as having an exemplary 256 pages each.

Each allocation unit 508, shown on the right portion of FIG. 5, has an allocation page 512 used to indicate which pages 514 of the allocation unit are free or used. The allocation unit has a plurality of data pages 514 over a contiguous storage space, and the allocation units 508 themselves are contiguous with their immediate neighbors as tracked by the GAM.

Using these techniques, it is therefore possible to not only allocate large portions of space for use by dynamic hash tables, but to also handle the allocation in an efficient manner. One of ordinary skill in the relevant arts will also recognize the extensibility of some of the aforementioned concepts. For example, the GAM status bits for each AU can instead be extended into bytes of data, allowing dynamic hash tables to be created on any segment.

### VI. Example Computer System Implementation

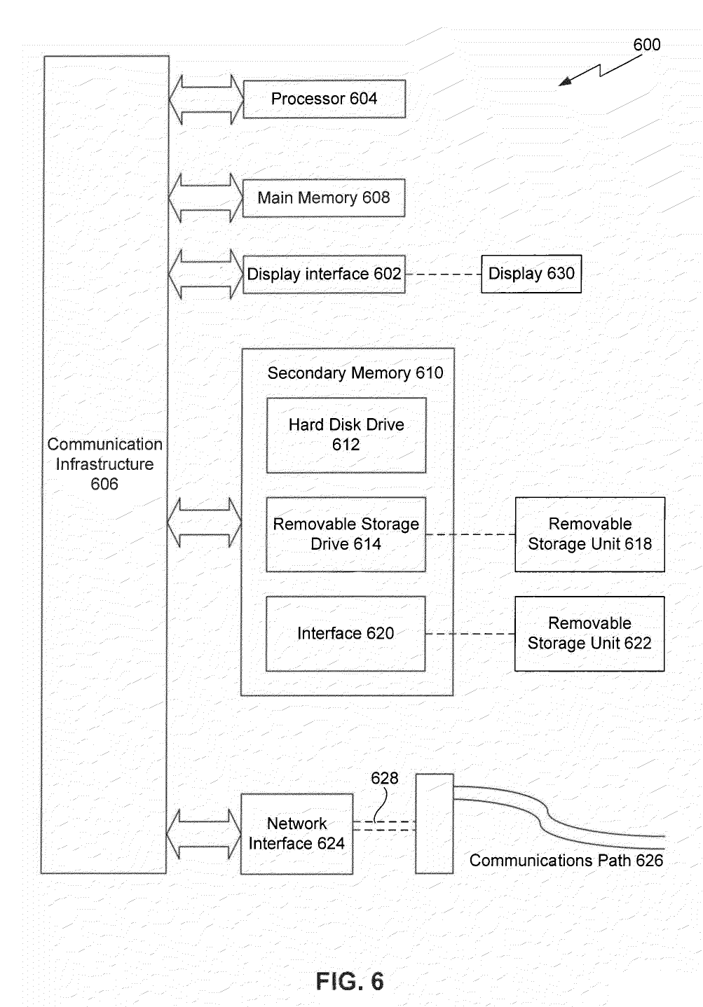

Various aspects of the present invention can be implemented by software, firmware, hardware, or a combination thereof. FIG. 6 illustrates an example computer system 600 in which the present invention, or portions thereof, can be implemented as computer-readable code. For example, the methods illustrated by flowcharts 200 of FIG. 2, 300 of FIGS. 3, and 400 of FIG. 4, can be implemented in system 600. Various embodiments of the invention are described in terms of this example computer system 600. After reading this description, it will become apparent to a person skilled in the relevant art how to implement the invention using other computer systems and/or computer architectures.

Computer system 600 includes one or more processors, such as processor 604. Processor 604 can be a special purpose or a general purpose processor. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612, a removable storage drive 614, and/or a memory stick. Removable storage drive 614 may comprise a floppy disk drive, a magnetic tape drive, an optical disk drive, a flash memory, or the like. The removable storage drive 614 reads from and/or writes to a removable storage unit 618 in a well-known manner. Removable storage unit 618 may comprise a floppy disk, magnetic tape, optical disk, etc. that is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 that allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals that may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, and a hard disk installed in hard disk drive 612. Signals carried over communications path 626 can also embody the logic described herein. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the methods illustrated by flowcharts 200 of FIG. 2, 300 of FIGS. 3, and 400 of FIG. 4, discussed above. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### VII. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method comprising:
creating a dynamic hash table segment on a database; and
creating a dynamic hash table within the dynamic hash table segment, the dynamic hash table comprising one or more contiguous allocation units having a plurality of contiguous pages and allocated on a per-allocation unit basis.

2. The method of claim 1, further comprising:
determining availability of the contiguous allocation units from a global allocation manager, the global allocation manager tracking the availability of the contiguous allocation units in a sequence based on their location in contiguous storage space.

3. The method of claim 2, further comprising:
locking access to the global allocation manager by other threads of execution prior to access thereof; and
unlocking access to the global allocation manager.

4. The method of claim 1, further comprising:
logging records for the contiguous pages, the records comprising old and new timestamp information, wherein the records are usable to recover a failed transaction to create the dynamic hash table.

5. The method of claim 4, further comprising:
flushing the records to disk.

6. The method of claim 1, further comprising: initializing the contiguous pages.

7. The method of claim 6, wherein initializing the contiguous pages comprises:
storing address information in an object allocation management page of the dynamic hash table; and
marking used pages of the plurality of contiguous pages in an allocation page of a corresponding allocation unit.

8. The method of claim 1, further comprising:
marking the contiguous allocation units as reserved in a global allocation manager; and
flushing changes to the global allocation manager to disk.

9. A computer-readable storage device having stored thereon instructions, execution of which, by a computing device, cause the computing device to perform operations comprising:
creating a dynamic hash table segment on a database; and
creating a dynamic hash table within the dynamic hash table segment, the dynamic hash table comprising one or more contiguous allocation units having a plurality of contiguous pages and allocated on a per-allocation unit basis.

10. The computer-readable storage device of claim 9, the operations further comprising:
determining availability of the contiguous allocation units from a global allocation manager, the global allocation manager tracking the availability of the contiguous allocation units in a sequence based on their location in contiguous storage space.

11. The computer-readable storage device of claim 10, the operations further comprising:
locking access to the global allocation manager by other threads of execution prior to access thereof; and
unlocking access to the global allocation manager.

12. The computer-readable storage device of claim 9, the operations further comprising:
logging records for the contiguous pages, the records comprising old and new timestamp information, wherein the records are usable to recover a failed transaction to create the dynamic hash table.

13. The computer-readable storage device of claim 12, the operations further comprising:
flushing the records to disk.

14. The computer-readable storage device of claim 9, the operations further comprising:
initializing the contiguous pages.

15. The computer-readable storage device of claim 14, wherein initializing the contiguous pages comprises:
storing address information in an object allocation management page of the dynamic hash table; and
marking used pages of the plurality of contiguous pages in an allocation page of a corresponding allocation unit.

16. The computer-readable storage device of claim 9, the operations further comprising:
marking the contiguous allocation units as reserved in a global allocation manager; and
flushing changes to the global allocation manager to disk.

17. A system comprising:
a memory configured to store modules comprising:
a first creating module configured to create a dynamic hash table segment on a database, and
a second creating module configured to create a dynamic hash table within the dynamic hash table segment, the dynamic hash table comprising one or more contiguous allocation units having a plurality of contiguous pages and allocated on a per-allocation unit basis; and
one or more processors configured to process the modules.
